(19) United States
(12) Patent Application Publication
(10) Pub. No.: US 2003/0148076 A1
(43) Pub. Date: Aug. 7, 2003

(54) Composite fabric for shoes

(76) Inventor: Hsi-Ming Huang, Yun-Lin Hsien (TW)

Correspondence Address: LADAS & PARRY, 26 West 61st Street, New York, NY, 10023-7604, US

(21) Appl. No.: 10/347,964

(22) Filed: Jan. 21, 2003

(30) Foreign Application Priority Data
Feb. 1, 2002 (TW) 091201158

(51) Int. Cl. B32B 5/26; B32B 3/00; B32B 27/14

(52) U.S. Cl. 428/196; 442/268; 428/198; 442/277

(57) ABSTRACT

A composite fabric for a shoe includes an air permeable substrate made of a thermoplastic fibrous material, an air permeable face layer made of a thermoplastic material, a plurality of spaced apart connecting lines provided on the face layer for bonding the face layer to the substrate, and a plurality of connection-free areas defined among the connecting lines. Each of the connecting lines is composed of a plurality of spaced apart welding points

### CROSS-REFERENCE TO RELATED APPLICATION

This application claims priority of Taiwanese application No. 091201158, filed on Feb. 1, 2002.

### BACKGROUND OF THE INVENTION

1. Field of the Invention

The invention relates to a fabric, more particularly to a composite fabric for a shoe.

2. Description of the Related Art

A composite fabric is usually used for making a shoe so as to obtain a balance of the various properties imposed by the different materials from which the composite fabric is composed. Conventionally, an adhesive is used for adhering the various materials together to form the composite fabric. However, the conventional composite fabric made by using the adhesive has shortcomings, such as inferior air permeability, increased overall weight of the composite fabric product, and reduced flexibility.

### SUMMARY OF THE INVENTION

Therefore, the object of the present invention is to provide a composite fabric for a shoe, which is produced without using adhesives, so as to overcome the shortcomings of the prior art.

According to this invention, a composite fabric for a shoe includes:

an air permeable substrate made of a thermoplastic fibrous material;

an air permeable face layer made of a thermoplastic material;

a plurality of spaced apart connecting lines provided on the face layer for bonding the face layer to the substrate, each of the connecting lines being composed of a plurality of spaced apart welding points; and

a plurality of connection-free areas defined among the connecting lines.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of the first preferred embodiment of a composite fabric for a shoe according to this invention;

FIG. 2 is a schematic view showing the production of the first preferred embodiment;

FIG. 3A is a fragmentary sectional view of the first preferred embodiment;

FIG. 3B is a fragmentary enlarged sectional view of the first preferred embodiment;

FIG. 4A is a fragmentary sectional view of the second preferred embodiment of a composite fabric for a shoe according to this invention;

FIG. 4B is a fragmentary enlarged sectional view of the second preferred embodiment;

FIG. 5 is a perspective view of the third preferred embodiment of a composite fabric for a shoe according to this invention;

FIG. 6 is a fragmentary sectional view of the third preferred embodiment; and

FIG. 7 is a fragmentary sectional view of the fourth preferred embodiment of a composite fabric for a shoe according to this invention.

### DETAILED DESCRIPTION OF THE PREFERRED EMBODIMENTS

Before the present invention is described in greater detail, it should be noted that like elements are denoted by the same reference numerals throughout the disclosure.

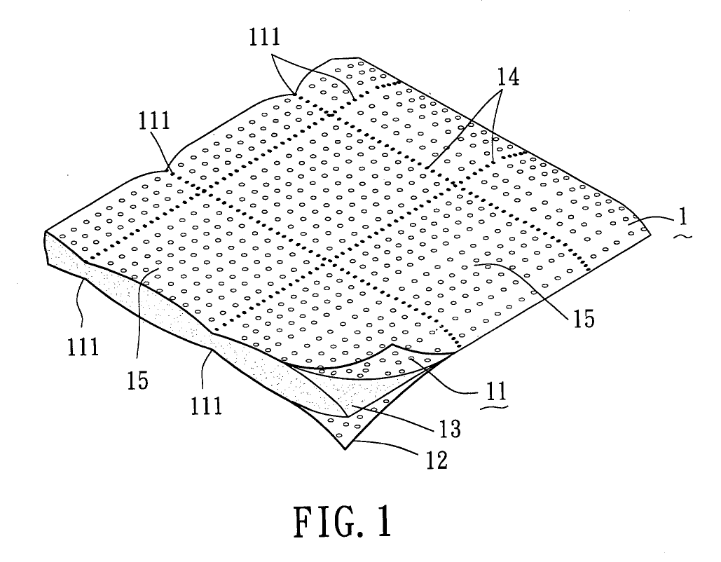

Referring to FIG. 1, the first preferred embodiment of a composite fabric 1 for a shoe according to this invention includes an air permeable substrate 13 made of a thermoplastic fibrous material, and air permeable first and second face layers 11, 12 made of thermoplastic materials, overlying the air permeable substrate 13, and opposite to each other. Preferably, the air permeable substrate 13 is a non-woven fiber web, and the first and second face layers 11, 12 are woven fabric materials. In this preferred embodiment, the air permeable substrate 13 is made of long fibers, and each of the first and second face layers 11, 12 is made of nylon.

The first and second face layers 11, 12 are respectively bonded onto the opposite surfaces of the air permeable substrate 13 through a plurality of spaced apart connecting lines 111. Each of the connecting lines 111 is composed of a plurality of spaced apart welding points 14. A plurality of connection-free areas 15 are defined among the connecting lines 111. In this preferred embodiment, the connecting lines 111 are arranged in a crisscross pattern, and each of the connection-free areas 15 has four sides.

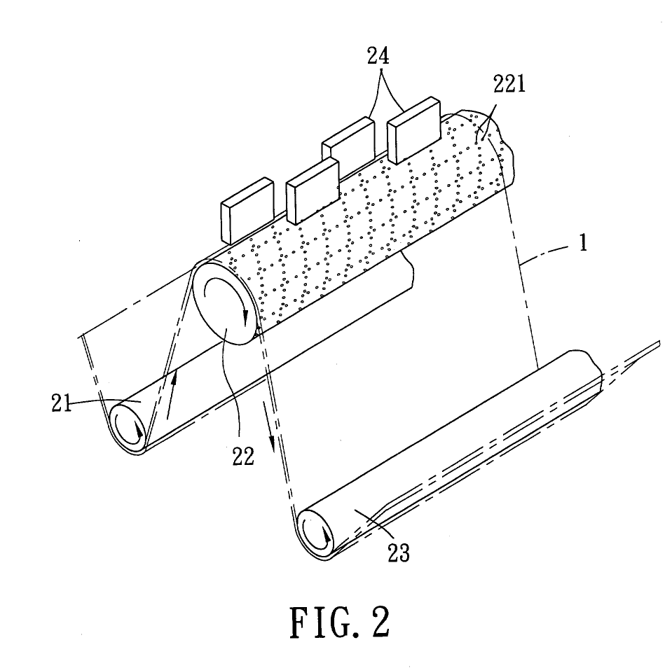

Referring to FIG. 2, in the production of the aforesaid preferred embodiment, the materials for the first and second face layers 11, 12 and the material for the air permeable substrate 13, which is sandwiched between the materials for the first and second face layers 11, 12, are advanced through first, second and third rollers 21, 22, 23 by the cooperative action of a feeding device and a winding device (not shown). A plurality of high frequency welding units 24 are mounted above the second rollers 22. The surface of the second roller 22 is provided with a plurality of protruding points 221 defining a pattern for forming the connecting lines 111 of the composite fabric 1.

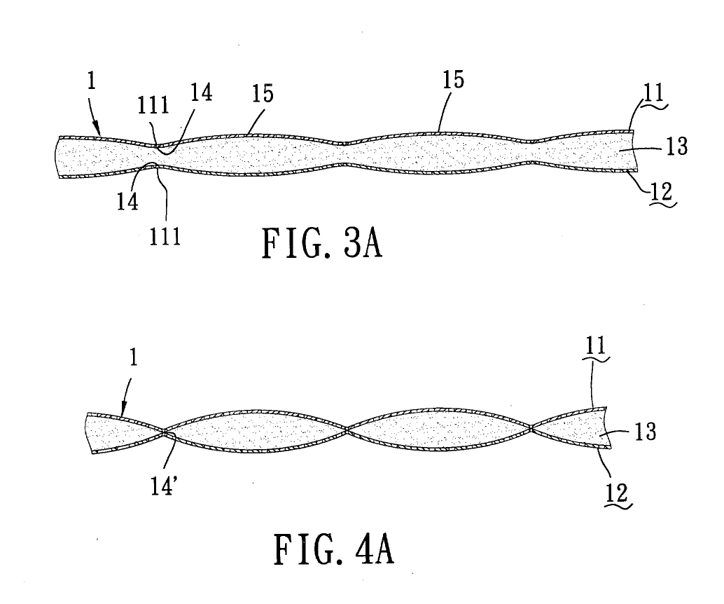

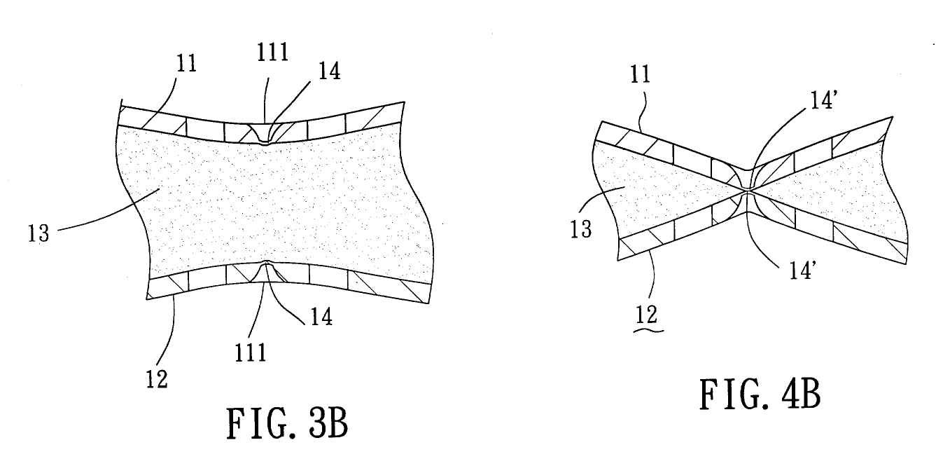

The high frequency welding units 24 abut against the portions of the materials for the composite fabric 1 on the second roller 22 so as to conduct high frequency welding. When the high frequency welding units 24 act on the materials for the composite fabric 1, the winding device and the second roller 22 cooperate to tense the portion of the materials for the composite fabric 1 therebetween. Referring to FIGS. 1, 3A and 3B, the action of the high frequency welding permits the first and second face layers 11, 12 to bond onto the opposite surfaces of the air permeable substrate 13 respectively through the plurality of welding points 14. Each of the welding points 14 is formed as a transparent or translucent film. The welding points 14 constitute two sets of a plurality of connecting lines 111 provided on the first and second face layers 11, 12 respectively and corresponding to each other. A plurality of the connection-free areas 15 are then defined among the connecting lines 111.

Referring to FIGS. 4A and 4B, the second preferred embodiment of the composite fabric 1 is substantially identical to the first preferred embodiment except that the welding points 14′ are formed in a manner that the first face layer 11, the air permeable substrate 13, and the second face layer 12 are bonded together at the welding points 14′ as a result of the high frequency welding.

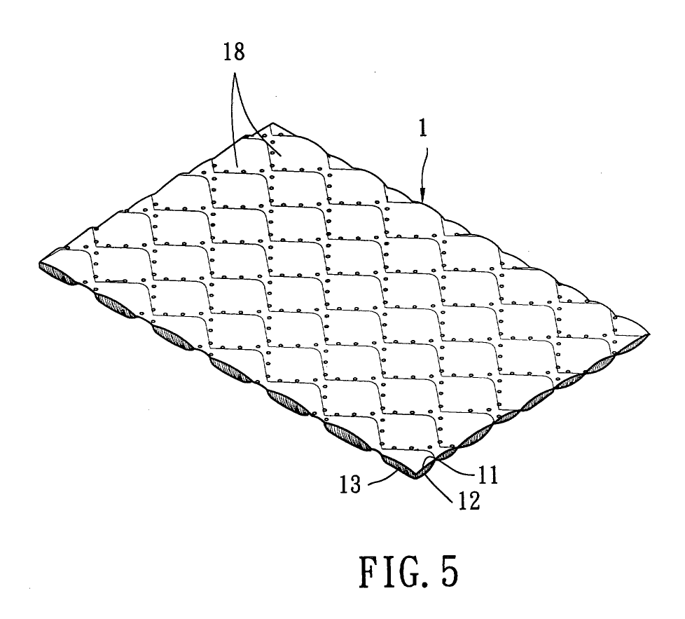

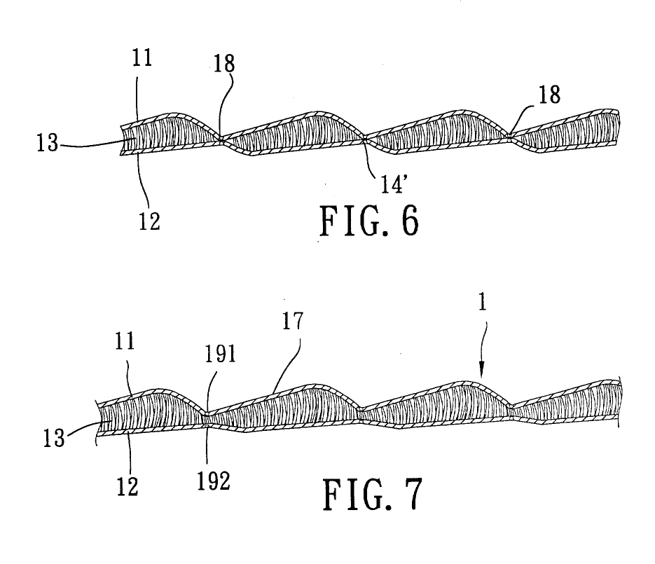

Referring to FIGS. 5 and 6, the third preferred embodiment of the composite fabric 1 according to this invention is substantially identical to the second preferred embodiment except that a different pattern defined by the spaced apart connecting lines 18 is formed by controlling the tension produced by the winding device and the roller (not shown). Each of the plurality of the welding points 14′ is formed by welding the first face layer 11, the air permeable substrate 13, and the second face layer 12 together.

Referring to FIG. 7, the fourth preferred embodiment of the composite fabric 1 according to this invention is substantially identical to the third preferred embodiment except that two sets of the welding points 191, 192 are respectively formed by welding together the first face layer 11 and the air permeable substrate 13 and by welding together the air permeable substrate 13 and the second face layer 12.

Even though the air permeable substrate 13 illustrated in the aforesaid preferred embodiments is made of a single material, it can also be composed of a plurality layers of different thermoplastic fibrous materials. The thermoplastic fibrous materials suitable for the air permeable substrate 13 used in the present invention can be appropriately selected by one skilled in the relevant art in view of the disclosure of this invention. Similarly, in addition to nylon, other thermoplastic materials (such as polyester) can be independently used for the first and second face layers 11, 12 under the condition that they can be processed by the welding process. Furthermore, the materials for the air permeable substrate 13 and the first and second face layers 11, 12 can be identical or different from each other.

Since the welding points 14, 14′ are transparent or translucent, the first and second face layers 11, 12 of different colors can be welded to form the welding points 14, 14′ with a compound color that is a result of the combination of the colors of the first and second face layers 11, 12, thereby enhancing the appearance of the composite fabric 1.

The following are some of the advantages of the composite fabric of this invention:

1. Enhanced air permeability: The thermoplastic materials for the composite fabric of this invention are bonded through the spaced apart welding points, rather than by adhesive. Furthermore, since the connection-free areas of the composite fabric of this invention are formed in an expansive shape, a plurality of air permeable spaces can be formed between the composite fabric of this invention and the skin of the user when the composite fabric of this invention is used to produce an article, such as a shoe. Therefore, air permeability can be enhanced with the use of the composite fabric of this invention.

2. Relatively light in weight: Since the adhesive conventionally used in the prior art is not required in the composite fabric of this invention, the overall weight of the composite fabric of this invention is relatively light as compared to that of the prior art.

3. Maintenance of flexibility: Since adhesive is not used for the composite fabric of this invention, the flexibility of the composite fabric of this invention imposed by the materials used therein can be maintained.

4. Aesthetic appearance: Since each of the plurality of the connection-free areas is formed in an expansive shape, a stereometric pattern can be formed on the composite fabric of this invention.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A composite fabric for a shoe, comprising:
an air permeable substrate made of a thermoplastic fibrous material;
an air permeable first face layer made of a thermoplastic material;
a plurality of spaced apart connecting lines provided on said first face layer for bonding said first face layer to said substrate, each of said connecting lines being composed of a plurality of spaced apart welding points; and
a plurality of connection-free areas defined among said connecting lines.

2. The composite fabric as claimed in claim 1, wherein said connecting lines are arranged in a crisscross pattern, and each of said connection-free areas has four sides.

3. The composite fabric as claimed in claim 1, wherein said welding points are formed using high frequency welding.

4. The composite fabric as claimed in claim 1, wherein said substrate is a non-woven fiber web.

5. The composite fabric as claimed in claim 4, wherein said first face layer is a woven fabric material.

6. The composite fabric as claimed in claim 1, wherein each of said thermoplastic fibrous material and said thermoplastic material is a fiber selected from the group consisting of polyester fiber and nylon fiber.

7. The composite fabric as claimed in claim 1, wherein said substrate is made of long fibers.

8. The composite fabric as claimed in claim 1, further comprising an air permeable second face layer overlying said substrate and opposite to said first face layer, said second face layer being bonded to said substrate through said connecting lines.

9. The composite fabric as claimed in claim 8, wherein said second face layer is made of a material selected from the group consisting of polyester fiber and nylon.
